(19) United States
(12) Patent Application Publication
(10) Pub. No.: US 2024/0082796 A1
(43) Pub. Date: Mar. 14, 2024

(54) Method and Apparatus for Diffusing Gas into a Liquid

(71) Applicant: HYDRENESIS DELTA SYSTEMS LLC, POMPANO BEACH, FL (US)

(72) Inventors: Luke Stephen Timmons, Pompano Beach, FL (US); Matthew Richard Rece, Fort Lauderdale, FL (US)

(73) Assignee: HHYDRENESIS DELTA SYSTEMS LLC, POMPANO BEACH, FL (Us)

(21) Appl. No.: 18/301,968

(22) Filed: Apr. 17, 2023

Related U.S. Application Data
(60) Provisional application No. 63/331,562, filed on Apr. 15, 2022.

(51) Int. Cl. B01F 35/22; B01F 23/231; B01F 35/213; B01F 35/221; C02F 1/00; C02F 1/70; C25B 1/04; C25B 15/023; C25B 15/08

(52) U.S. Cl. CPC B01F 35/2202; B01F 23/2312; B01F 35/213; B01F 35/2211; B01F 35/2213; C02F 1/008; C02F 1/70; C25B 1/04; C25B 15/023; C25B 15/081; B01F 2101/305; C02F 2209/03; C02F 2209/04; C02F 2209/38; C02F 2303/08

(57) ABSTRACT

A method and apparatus for diffusing or reducing gas into a liquid is described. This invention covers several different methods for infusing or reducing gas into a liquid with a feedback loop that monitors specific parameters of the process and can vary controls to achieve a targeted value or keep within a range of values. The parameter of interest is the ORP (Oxidative Reduction Potential) and one way to determine that value is using an ORP sensor to directly measure it at various points in the process such as on the untreated incoming process fluid, right after infusing the reducing gas, or later in the process such as where the fluid is discharged back into the original tank in the case of a recirculating system or when it is discharged to the next phase of the treatment train.

### PRIOR APPLICATION

This application claims the benefit of U.S. provisional application No. 63/331,562, that was filed on Apr. 15, 2022, the contents of which are hereby incorporated by reference.

### TECHNICAL FIELD

The described embodiments relate to a method and a system for diffusing gas into a liquid.

### BACKGROUND OF THE INVENTION

A method and apparatus for diffusing gas into a liquid is disclosed. A gas, such as O₂ or ozone has been infused with a diffuser into liquids or fluids within a holding tank to generate a chemical reaction of the fluid or to change the characteristics of the fluid. The characteristics of the fluid may need to be changed to cleanse the fluid by disinfecting impurities, or to aerate the fluid. Such characteristics provide an advantage in an aquaculture or food producing environment.

One type of gas that has been injected into fluids is a reducing gas. Such gas has been known to provide positive attributes to the fluid. However, the volume of reducing gas to insert has been based on fluid characteristics, such as temperature, fluid pressure, amount of gas produced as a reaction to the gas. Basing the volume of reducing gas to insert on these fluid characteristics has led to less than desirable results.

### SUMMARY OF THE INVENTION

One general aspect includes a method for diffusing a gas (e.g., an electrolytic or reducing gas) into a liquid, based on oxidation reduction potential (“ORP”) levels. In this method, a fluid is provided in which gas is to be injected. The ORP of the fluid is continually and periodically sensed. In response to the sensed ORP, the rate at which gas is injected into the fluid is adjusted in real time.

In another implementation, an apparatus for injecting an electrolytic or reducing gas into a liquid includes a liquid tank for holding the liquid. A gas contactor combines liquid and electrolytic gas and injects the combination into the liquid tank, and an electrochemical cell generates the electrolytic gas. A pressure controller feeds a volume of electrolytic gas generated by the electrochemical cell to the gas contactor. An oxidation reduction potential (ORP) sensor detects an ORP level of the liquid in the liquid tank. A controller adjusts a rate that the pressure controller feeds the volume of the electrolytic gas to the gas contactor based on ORP level detected by the ORP sensor.

In a further implementation a system for injecting an electrolytic or reducing gas into a liquid includes a liquid tank for holding the liquid and containing a diffuser operative to inject the electrolytic gas into the liquid tank. An electrochemical cell generates electrolytic gas. A pump feeds a volume of electrolytic gas generated by the electrochemical cell to the diffuser. At least one of an electro chemical cell controllers is electrically coupled with plates in the electro chemical cell to control a rate at which the electrochemical cell generates the electrolytic gas. A bypass controller adjusts the flow of fluid from the electrochemical cell to the diffuser. An oxidation reduction potential (ORP) sensor detects an ORP level of the liquid in the liquid tank, and a controller adjusts at least one of (a) a rate that the pump feeds the volume of the electrolytic gas, (b) a rate the electro chemical cell controller causes the plates to generate electrolytic gas, and (c) the flow of the fluid from the electrochemical cell to the diffuser, based on ORP level detected by the ORP sensor.

Another way that one might determine the concentration of gas needing to be infused would be to monitor the BOD and COD (Biological Oxygen Demand and Chemical Oxygen Demand) at those same points in the stream as described herein and from that one can determine the ability of the fluid to take in and use up the reducing gas being provided and then adjust the infusion concentration accordingly.

### BRIEF DESCRIPTION OF THE DRAWINGS

The detailed description is described, with reference to the accompanying figures. In the figures, the left-most digit(s) of a reference number identifies the figure in which the reference number first appears. The use of the same reference number in different figures indicates similar or identical items.

FIG. 1 is a system diagram illustrating the diffusion of an electrolytic gas into a liquid;

FIG. 2 is a system diagram illustrating the diffusion of an electrolytic gas into a liquid under pressure;

FIG. 3 is a system diagram illustrating the diffusion of an electrolytic gas into a liquid provided at a variable flow;

FIG. 4 is a simplified system diagram illustrating a logic controller for controlling diffusion of the electrolytic gas; and

FIG. 5 is an example flow diagram of a process for controlling the diffusion of electrolytic gas in a liquid, executed by the logic controller shown in FIG. 4.

### DETAILED DESCRIPTION

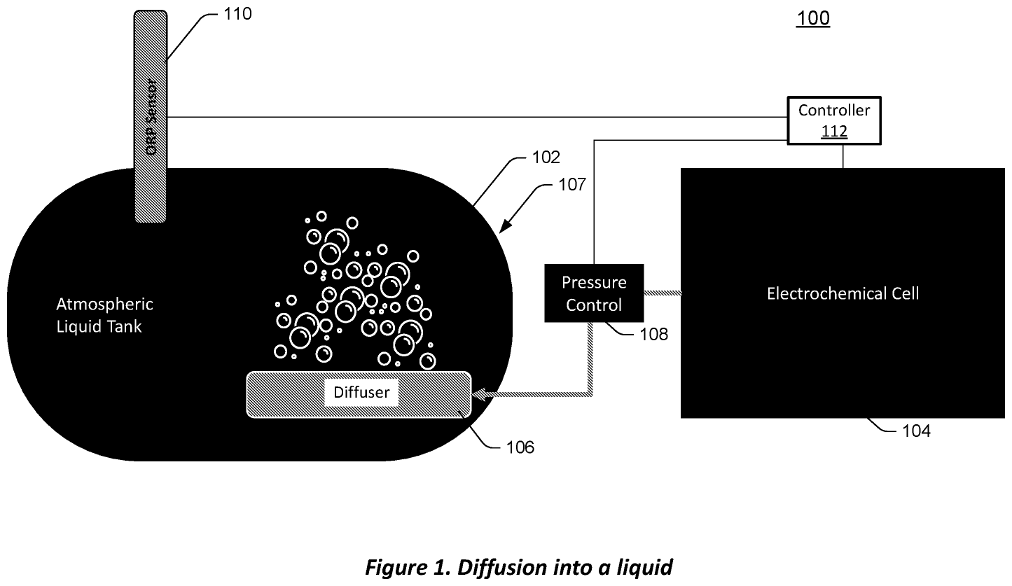

In FIG. 1, there is shown a system 100 for controlling the diffusion of an electrolytic gas or reducing gas in a liquid (including water or other process fluid, such as oil). In one implementation, system 100 includes an atmospheric liquid tank 102 coupled with an electrochemical cell 104. The atmospheric liquid tank 102 contains a gas diffuser or air stone 106 submerged in the tank liquid, which feeds gas 107 (such as reducing gas) into tank 102. A sensor 110, such as an ORP sensor, continuously and/or at periodic intervals monitors liquid in tank 102 to determine the ORP (Oxygen Reduction Potential) level of the liquid in tank 102. The volume and pressure of gas 107 passing through diffuser 106 is set by pressure controller 108. Gas 107 may be produced on demand from electrochemical cell 104. In one implementation the electrolytic gas 107 may be produced off-site (e.g., at a remote location from system 100), stored, and transported to injection site for injection via pressure controller 108 into tank 102.

Reducing gases are compounds which react with atmospheric oxygen catalyzed on heated surfaces, such as the metal oxide layer of SGP4x sensors. Some examples of reducing gases are hydrogen (H2), volatile organic compounds (VOCs), carbon monoxide (CO) and methane (CH4). An electrolytic gas is formed by the electrolysis of water, and is typically a mixture of two parts of hydrogen and one part of oxygen by volume,

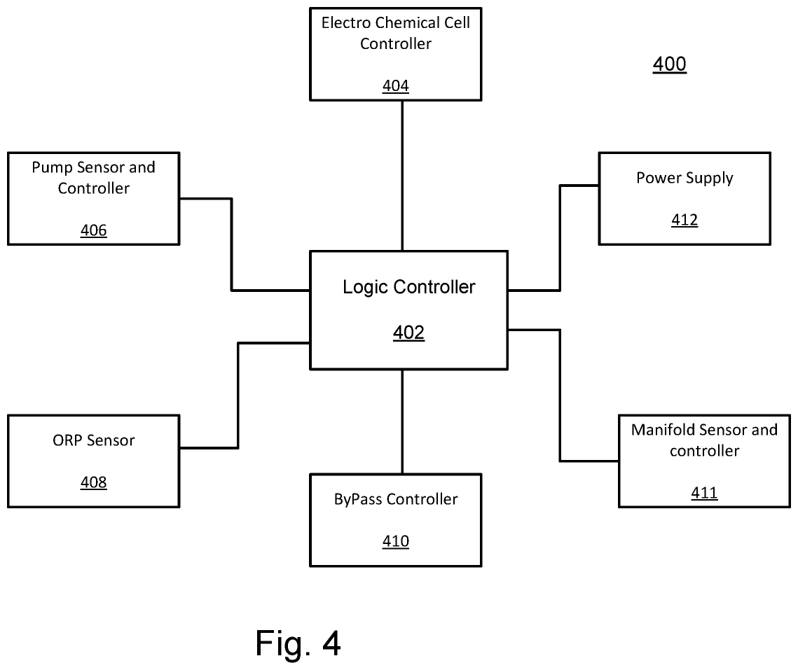

A logic controller 112 monitors the ORP sensor 110 and in response to changes to the ORP, provides an indication to the pressure controller 108 to change the pressure of the gas 107 originating from electrochemical cell 104. An electro chemical cell controller (controller 404 in FIG. 4) may be embedded in or coupled with logic controller 112 for controlling reactions in electrochemical cell 104. An exemplary electrochemical cell 104 includes an enclosed pair of metal plates (not shown), submerged into an electrolyte, which are positioned in a parallel orientation and have an applied voltage differential.

To generate the gas 107, a liquid (preferably a salient liquid) is passed between the charged plates resulting in a production of gas 107 and a buildup of pressure in the cell 104, which is controlled by a pressure controller 108. The rate at which gas 107 is generated by the electrochemical cell 104 may be a function of the voltage and amperage applied to the charged plates. Pressure controller 108 sets the pressure of generated gas 107 fed to diffuser 106 in response to readings from the ORP sensor 110. In one implementation, the volume and pressure of the gas 107 being fed to diffuser 106 decreases (and increases), as governed by controllers 112 and 108, based on readings from the ORP sensor. In another implementation, voltage/amperage applied to the charged plates within cell 104 may also be varied by controller 112, based on readings from the ORP sensor 110, to change the gas production rate in cell 104.

Methods to adjust the concentration of the reducing gas 107 can include increasing or decreasing the volume, pressure, or rate at which the reducing gas is produced and supplied to the infusion apparatus (e.g., diffuser 106). Another way to vary the reducing gas concentration could be to speed up or slow down the rate at which a process fluid or liquid is moved through the system to change the amount of process fluid through which the reducing gas is being diffused. In some cases, both methods can be used to achieve the targeted ORP value. For example if one were to aim to achieve a ORP value of −200 mv while maintaining a flow rate of at least 100 gpm, the logic controller (112) would monitor at all available parameters such as process fluid flow rate, Electrolytic cell 104 power settings, system pressure and reducing gas pressure and detect if the current ORP value is −150 mv and the flow rate of the process fluid is 125 gpm. If the power setting on the electrolytic cell 104 is 100%, logic controller 112 could provide an indication to slow a pump (in pressure controller 108) of the process fluid so that the reducing gas 107 is being infused into a smaller concentration of process fluid thereby increasing the concentration of the reducing gas 107 and lowering the ORP.

In another scenario the target ORP may range between −100 mv and −150 mv and the measured value is −200 mv. The logic controller 112 could either reduce the power settings on the Electrolytic cell 104 or increase the pump speed moving the process fluid. Methods for changing the rate at which electrolytic gas 107 is being produced include adjusting the voltage or current limits on the power supply for the electrolytic cell 104 or adjusting the max pressure for the reducing gas 107 in the cell 104. When the reducing gas pressure limits are reached the power to the plates in cell 104 is reduced or paused until the created gas is consumed and the pressure is reduced to a predetermined setpoint below a max pressure. Then the system will resume normal power settings again. This results in a regular rise and fall of the reducing gas pressure within a specified range. If an adjustment is made to the method of diffusion such as if more bubblers/air stones are added to the tank 102 or if more bubblers/air stones are enabled, then more reducing gas 107 will be needed before the system (in cell 104 or tank 102) can reach a pressure setpoint. The effect of the adjustment will manifest in a change in the rate of the rise and fall of the pressure of the reducing gas 107.

Methods outlined here for performing the actual diffusing of the gas 107 into the process fluid can be varied depending on the application. The first method described in FIG. 1 is direct diffusion into the process fluid in an atmospheric tank using a diffuser or air stone. Generally, the ORP or BOD/COD sensor could be directly measured in tank 102, and the process parameter can be adjusted is the number of diffusers that are activated in the tank. In this manner the amount of reducing gas being produced can be increased or decreased to meet the targeted ORP or BOD/COD values.

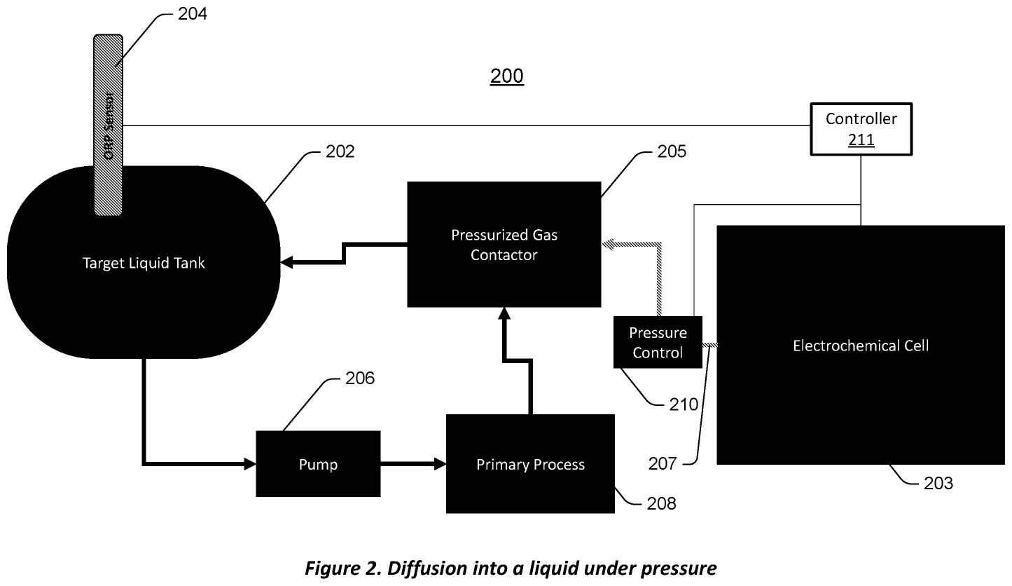

Referring to FIG. 2, there is shown a system 200 diffusing gas into a liquid (or process fluid) under pressure. In one implementation, system 200 includes a target liquid tank 202 coupled with a pressurized gas contactor 205 and pump 206. A sensor 204, such as an ORP sensor, monitors liquid in tank 202 to determine its ORP. Pump 206 is coupled via primary process 208, exemplary primary processes include but are not limited to bioreactors, reverse osmosis filtration, sediment filtration, advanced oxidation processes, and electrocoagulation to pressurize gas contactor 205. Contactor 205 passes the liquid through a contained gaseous “pocket”, where the gas is absorbed as the liquid passes through the pocket (not pictured). The pressure and flow of gas 207 is controlled by pressure control 210. The contactor 205 should be applied after fluid leaves from primary pr. ss 208. An electrochemical cell 203 is coupled via a pressure control 210 to pressurized gas contactor 205. Controller 211 is coupled to the ORP sensor 204, pressure control 210, and electrochemical cell 203. The pressure of gas being fed to the contactor is set by pressure controller 210, as needed to overcome the system pressure created by pump 206. The gas 207 originates from electrochemical cell 203.

During operation, a liquid under pressure is fed using pump 206 to primary process 208 where the liquid is treated. The liquid is fed to pressurized gas contactor 205 where gas from the electrochemical cell is mixed with the liquid. The mixed gas/liquid is fed to target liquid tank 202. The pressure of the gas from cell 203 is set by pressure control 210.

Controller 211 monitors the ORP sensor 204 and in response to changes to the ORP sensor 204, controller 211 provides an indication to the pressure control 210 to change the pressure of the gas 207 originating from electrochemical cell 203 being fed to contactor 205. In response to ORP levels, Controller 211 sets the gas production rate in cell 203.

In FIG. 2 the pressurized gas contactor 205 may be part of the treatment train for the process fluid or may be a separate side loop to infuse the reducing gas 207. The reducing gas 207 may be injected into a sealed volume in which the process fluid could be injected through holes in a perforated plate to create droplets, increase the surface area of the process fluid and increase the fluids' ability to absorb or dissolve the reducing gas into it. In this process, the pressure and flow rate of the process fluid, and the pressure of the reducing gas (210) can be controlled to closely match the system pressure. The pressure of the reducing gas 207 can be controlled by varying the power or pressure parameters of the electrolytic cell 203 in which the reducing gas 207 is produced.

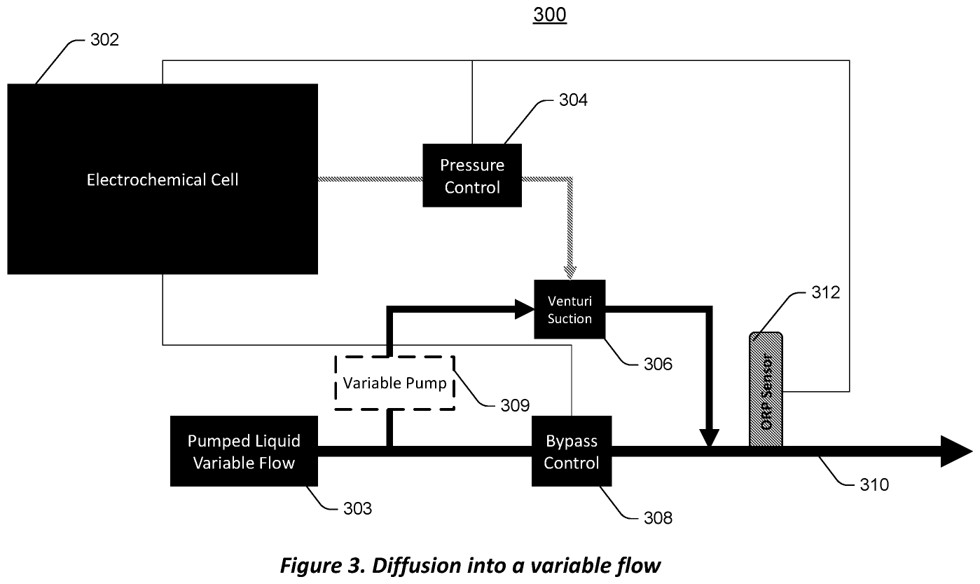

Referring to FIG. 3, there is shown a system 300 diffusing gas into a variable flowing liquid 303. In one implementation, system 300 includes an electrochemical cell 302 coupled via pressure control 304 to venturi suction device 306. A bypass control 308 is coupled to a pumped liquid variable flow in parallel with venturi suction device 306 to output 310. An ORP sensor 312 monitors the ORP of liquid flowing to output 310. Cell 302, pressure control 304, and bypass control 308 are controlled by a logic controller (See FIG. 4). In one embodiment in which a secondary pump is used, variable pump 309 may be substituted for bypass control 308.

During operation, pumped liquid is simultaneously fed to venturi suction device 306 and bypass control 308. Gas generated by cell 302 and regulated by pressure control 304 is injected into liquid using venturi suction device 306. The controller monitors the ORP from sensor 312, and in response to varying ORP levels and fluid flow rate, the controller sends a signal to bypass control 308 to open and close to control the amount of pressurized gas being inserted at venturi suction 306, the gas production rate of cell 302, and the amount of pressure generated by pressure control 304. In another implementation, in lieu of bypass control 308, an additional pump may be used to control the venturi suction 306, creating a pressure differential across the venturi 306, driving the suction.

In FIG. 3, infusing the gas into the process fluid utilizes a side loop off a main line that has a venturi 306. The venturi 306 can be used in a system where the pressure inside the lines for the process fluid is above the max working pressure for the reducing gas. The venturi 306 uses the process fluid to function as the motive flow for the venturi to create suction to draw the reducing gas into the process fluid. The bypass control valve (308) can be adjusted to increase or decrease the motive flow being provided to the venturi which directly controls the amount of suction that it generates which correlates to the volume of reducing gas being injected into the process fluid. If the ORP, COD/BOD needs to be raised or lowered then the bypass control valve can be changed to create more or less suction. If the volume of the reducing gas being produced is not sufficient to meet the demands of the suction, then the amount of reducing gas being produced can be adjusted via methods previously described. Another variation of this apparatus uses a secondary variable speed pump on the side loop leading to the venturi and instead of using a bypass control valve. The bypass control valve creates more back pressure for the main system pump and forces it to work harder to maintain a constant flow rate when more of the flow is diverted through the side loop/venturi and in systems where additional pump power isn't available on the main system pump the secondary pump can be used to increase the motive flow to the venturi without increasing the workload for the system pump and while maintaining the prescribed process fluid flow rate.

Referring to FIG. 4, there is shown a system 400 containing a logic controller 402 (such as logic controller 112 in FIG. 1) used to control the systems 100, 200, and/or 300 shown in FIGS. 1-3. Logic controller 402 may be a microprocessor with associated memory and instructions set, coupled with input/output control logic.

Controller 402 may be coupled with an electrochemical electro-coagulation (“EC”) Cell and/or EC cell controller 404, a pump sensor and controller 406 (e.g., pressure controller 108 of FIG. 1), an ORP sensor 408 (sensor 110 of FIG. 1), a bypass controller 410, a manifold (pressure) sensor and controller 411, and a power supply 412 (coupled to charged plates in cell 104).

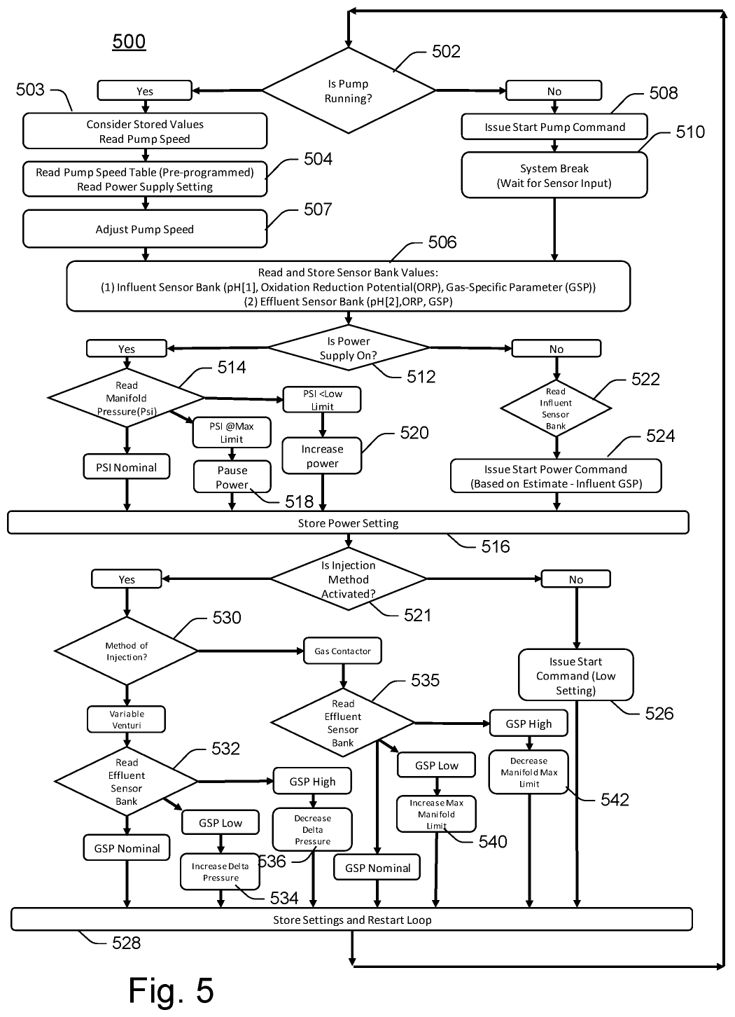

The exemplary process in FIG. 5 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform functions or implement abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 5, there is shown a flowchart of a process 500 performed by logic controller 402 when executing the software instructions. The process 500 includes multiple blocks 502-542.

In process 500, controller 402 determines if a pump is running by reading pump sensor and controller 406 in block 502.

If the pump is running, controller 402 reads the pump speed in block 503, reads a pump speed table (pre-programmed) in block 504 and adjusts the pump speed in accordance with the value provided in the table in block 507.

If the pump is not running, the controller 402 issues a start pump command in block 508 and issues a system break (to wait for pump sensors to indicate the pump is running) in block 510.

Controller then reads the ORP sensor, and stores sensor bank values (specifically ORP, or any gas specific parameter) in block 506.

In block 512, controller 402 determines if the power supply is on. If the power supply is on, controller 402 reads the manifold pressure in block 514. If the pressure is normal, the controller stores the power setting in block 516. If the pressure is at its maximum limit, the power is paused in block 518 before executing block 516. If the pressure is low, or below a preset low limit, the power is increased in block 520 before executing block 516.

If the power supply is determined to be off in block 512, the ORP sensor is read in block 522, and a start power command (based on the ORP reading, assuming that the ORP is needed to be further reduced, is sent to the power supply on the electrochemical cell in block 524 before executing block 516.

After storing the power settings in block 516, a determination is made as to which gas injection method is activated in block 521. If the injection method is not activated, then in block 526, a start command is sent out, settings are stored in block 528, and the loop restarts in block 502 by determining if the pump is running.

If a determination is made in block 518 that an injection method is active, then in block 530, a determination is made as to which method of gas injection is active (e.g., the system in FIG. 1, FIG. 2, or FIG. 3). If the method of gas injection is using a venturi, the controller 402 reads the ORP sensor in block 532, and depending on the ORP level, will increase or decrease the pressure differential of the gas injection. For example if the ORP level is low, then in block 534, a signal will be sent by the controller 402 to the pressure controller to increase the gas pressure, or if the signal from the ORP sensor indicates the ORP level is high, then in block 536, the controller will send a signal to pressure controller to decrease the rate of gas injection. If the ORP is normal, block 528 is executed.

If the controller 402 decides, in block 530, that the method of injection is Gas contactor, then in block 535, the ORP sensor is read and a controller 402 makes a determination if the ORP level is normal, high, or low before sending a signal to the manifold to increase or decrease the manifold limit. If the ORP level is low, then in block 540 a signal will be sent by the controller 402 to the pressure controller to increase the maximum manifold limit, or if the signal from the ORP sensor indicates the ORP level is high, then in block 542 controller will send a signal to the pressure controller to lower the manifold maximum limit, thus reducing the rate of gas injection. If the ORP is normal, block 528 is executed.

Controller 402 stores setting in block 528, and the loop restarts in block 502 by determining if a pump is running.

Another way that one might determine the concentration of gas needing to be infused would be to monitor the BOD and COD (Biological Oxygen Demand and Chemical Oxygen Demand) at those same points in the stream as listed previously and from that one can determine the ability of the fluid to take in and use up the reducing gas being provided and then adjust the infusion concentration accordingly.

Any combination of influent and effluent sensor banks can be used to help with determining the depletion rate of the reducing gas in the system and then that information can be used to adjust the system parameters to achieve the ORP or BOD/COD targets of the system.

In yet another embodiment, the system may incorporate a heat exchanger that utilizes the treatment water to regulate the temperature within the electrolytic cell. This heat exchanger is designed to maintain an optimum temperature range for reducing gas production and is integrated into the control system, further enhancing the overall efficiency and effectiveness of the gas diffusion process.

The heat exchanger can be configured as a separate unit or integrated within the electrolytic cell itself, depending on the application and design requirements. The heat exchanger functions by transferring thermal energy between the treatment water and the electrolytic cell, ensuring that the electrolytic cell operates within the desired temperature range for optimal reducing gas production.

In this embodiment, temperature sensors are installed within the electrolytic cell and the treatment water to monitor their respective temperatures continuously. The information obtained from these sensors is fed into the control system, which adjusts the heat exchanger's operation accordingly. The control system can either increase or decrease the heat exchange rate between the treatment water and the electrolytic cell based on the temperature data, ensuring that the electrolytic cell operates within the optimum temperature range for reducing gas production.

The heat exchanger's operation can be further optimized by using a variable flow control mechanism for the treatment of water passing through it. This mechanism can regulate the flow rate of the treatment water in response to the temperature conditions within the electrolytic cell, allowing for more precise control over the heat exchange process.

By maintaining the electrolytic cell's temperature within the optimal range, the heat exchanger ensures consistent and efficient reducing gas production. Consequently, this leads to improved control and stability of the gas diffusion process, as well as enhanced performance in achieving the targeted ORP, BOD, or COD values.

In a further embodiment, an electrolytic cell is utilized for the simultaneous production of both H2 (hydrogen) and O2 (oxygen) gases. This process, already well-established in the field of hydrogen production, involves the separation of these gases through electrolysis. The reducing gas, such as hydrogen, can be infused into the treated liquid column, while the oxygen, an oxidative gas, can be employed in a different part of the treatment train or even in a separate treatment process.

The use of an electrolytic cell in this manner allows for more versatile and efficient management of the gas diffusion process, as it enables the system to produce and utilize both reducing and oxidative gases as needed. This can lead to enhanced performance in achieving targeted ORP, BOD, COD, or DO (Dissolved Oxygen) values, depending on the specific application and requirements.

In this embodiment, sensors, such as ORP, BOD, COD, or DO sensors, are strategically placed within the treatment train or separate treatment processes to continuously monitor the concentration of each gas. The data collected from these sensors is then fed into the control system, which dynamically adjusts the production rate of hydrogen and oxygen gases and their infusion into the respective treatment processes accordingly.

For instance, if the control system determines that the concentration of the reducing gas needs to be increased to achieve the desired ORP or BOD/COD values, it may increase the production rate of hydrogen gas in the electrolytic cell while maintaining or reducing the production rate of oxygen gas. Conversely, if the control system detects that the DO concentration needs to be increased in a different part of the treatment train or a separate treatment process, it can increase the production rate of oxygen gas while maintaining or reducing the production rate of hydrogen gas.

The electrolytic cell's operation can be further optimized by incorporating a power management system that adjusts the voltage, current limits, or pressure parameters of the cell. This allows for precise control over the production rate of hydrogen and oxygen gases, ensuring that the system produces the required concentrations of each gas based on the sensor feedback.

In another embodiment, one or more reducing gases can be infused into a closed or open liquid column to create a specific antioxidant environment, which can help reduce corrosion in infrastructure made of lead, copper, steel, alloy, or other materials susceptible to oxidation. This process can be beneficial in various applications, such as water distribution systems, cooling systems, and industrial processes where the prevention of corrosion is critical for the longevity and reliability of the infrastructure.

To achieve this antioxidant environment, the system continuously monitors one or more parameters, such as pH, ORP, total/free chlorine, temperature, and DO, using strategically placed sensors throughout the treatment train. The data collected from these sensors is fed into the control system, which dynamically adjusts the production and infusion of reducing gases at one or more points in the treatment train to maintain the desired antioxidant conditions.

The control system can be programmed with predefined setpoints or ranges for each parameter based on the specific antioxidant environment required for the infrastructure materials in use. The system will then adjust the production and infusion of reducing gases accordingly to maintain the parameter values within the desired setpoints or ranges. For example, if the control system detects that the ORP value is too high, indicating a more oxidative environment, it may increase the production and infusion of reducing gases to lower the ORP value and create a more antioxidant environment.

In cases where multiple reducing gases are used, the control system can also adjust the proportion of each gas infused into the liquid column to optimize the antioxidant environment for the specific infrastructure materials. This can be achieved by monitoring the relevant parameters and adjusting the production and infusion rates of each reducing gas accordingly.

By continuously monitoring and adjusting the gas production and infusion based on real-time sensor data, the system can maintain a specific antioxidant environment in the liquid column, effectively reducing corrosion in infrastructure made of materials susceptible to oxidation. This can lead to improved longevity and reliability of the infrastructure, as well as reduced maintenance and replacement costs.

In yet another embodiment, the system can be utilized to mitigate the production of trihalomethanes (THMs) and maintain chloramine production without allowing it to oxidize to trihalomethanes.

Trihalomethanes are harmful byproducts formed when chlorine reacts with organic matter present in water during the disinfection process. By carefully controlling the infusion of reducing gases and other parameters, the system can minimize the formation of THMs while still ensuring effective disinfection with chloramines.

To achieve this, the system continuously monitors a combination of parameters such as ORP, BOD, COD, temperature, alkalinity, pH, and total/free chlorine, using strategically placed sensors throughout the treatment train. Additionally, a secondary organic matter sensor can be incorporated into the control system to detect the concentration of organic matter that may interact with chlorine to produce THMs. The data collected from these sensors is fed into the control system, which dynamically adjusts the production and infusion of reducing gasses and other process parameters to maintain the desired conditions for chloramine production and minimize THM formation.

For instance, if the control system detects a high concentration of organic matter, it may adjust the production and infusion of reducing gasses to reduce the oxidative environment, thus minimizing the interaction between chlorine and organic matter, and limiting THM formation. Simultaneously, the system ensures that chloramine production is maintained at a sufficient level for effective disinfection.

The control system can be programmed with predefined setpoints or ranges for each parameter based on the specific requirements for mitigating THM production and maintaining chloramine levels. The system will then adjust the production and infusion of reducing gases and other process parameters accordingly to maintain the parameter values within the desired setpoints or ranges.

In cases where multiple reducing gases are used, the control system can also adjust the proportion of each gas infused into the liquid column to optimize the conditions for chloramine production and THM mitigation. This can be achieved by monitoring the relevant parameters and adjusting the production and infusion rates of each reducing gas accordingly.

By continuously monitoring and adjusting the gas production, infusion, and other process parameters based on real-time sensor data, the system can effectively mitigate the production of trihalomethanes and maintain chloramine production without allowing it to oxidize to trihalomethanes.

In another embodiment, the system can be utilized to create an antioxidative environment for neutralizing toxic free radicals within a liquid column, specifically for wastewater treatment applications. By controlling the reducing gas infusion to maintain a desired ORP level, the system can effectively neutralize harmful free radicals, leading to improved wastewater treatment results.

To achieve this, the system continuously monitors key parameters such as BOD, COD, pH, and ORP, using strategically placed sensors throughout the treatment train. The primary variable being controlled in this embodiment is the ORP level, which plays a crucial role in determining the antioxidative environment necessary for neutralizing toxic free radicals.

The data collected from these sensors is fed into the control system, which dynamically adjusts the production and infusion of reducing gases to maintain the desired ORP level. The control of the reducing gas can be achieved by varying either the flow rate of the gas or the amount of gas being produced.

For instance, if the control system detects a high ORP value, indicating a more oxidative environment, it may increase the production and infusion of reducing gases to lower the ORP value and create a more antioxidative environment. Conversely, if the ORP value is too low, the system may decrease the production and infusion of reducing gases to maintain the desired ORP level.

The control system can be programmed with predefined setpoints or ranges for the ORP level based on the specific requirements for neutralizing toxic free radicals in the wastewater treatment process. The system will then adjust the production and infusion of reducing gases accordingly to maintain the ORP values within the desired setpoints or ranges.

By continuously monitoring and adjusting the gas production and infusion based on real-time sensor data, the system can maintain a specific antioxidative environment in the liquid column, effectively neutralizing toxic free radicals and improving the efficiency of the wastewater treatment process.

While the above description identifies, describes, and details several novel features of the invention, as applied to a preferred embodiment, it should be understood that various omissions, substitutions, and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A method for diffusing gas into a liquid, the method comprising:
providing a fluid in which gas is to be injected;
sensing an oxidation reduction potential (ORP) level of the fluid; and
adjusting, in real time, a rate at which the gas is injected into the fluid in response to the sensed ORP level.

2. The method as recited in claim 1, wherein the gas to be injected is an electrolytic or a reducing gas.

3. The method as recited in claim 1, further comprising injecting the gas into a fluid within a liquid tank using a pump and a diffuser.

4. The method as recited in claim 3, further comprising sensing the ORP level with an ORP sensor in contact with the fluid within the liquid tank.

5. The method as recited in claim 4, wherein adjusting, in real time, a rate at which the reducing gas is injected into the fluid in response to the sensed ORP level includes adjusting with a logic controller electrically coupled with the ORP sensor and the pump.

6. An apparatus for injecting an electrolytic or reducing gas into a liquid comprising:
a liquid tank for holding the liquid;
a gas contactor operative to combine the liquid and the electrolytic or reducing gas and inject the combination into the liquid tank;
an electrochemical cell to generate the electrolytic gas;
a pressure controller to feed a volume of electrolytic gas generated by the electrochemical cell to the gas contactor;
an oxidation reduction potential (ORP) sensor to detect an ORP level of the liquid in the liquid tank; and
a controller to adjust a rate that the pressure controller feeds the volume of the electrolytic gas to the gas contactor based on ORP level detected by the ORP sensor.

7. The apparatus as recited in claim 6 further comprising a pump to pull liquid from the liquid tank.

8. The apparatus as recited in claim 6 wherein the gas contactor is a pressurized gas contactor.

9. A system for injecting a reducing gas into a liquid, the system comprising:
a liquid tank for holding the liquid and containing a diffuser operative to inject the reducing gas into the liquid tank;
an electrochemical cell to generate the electrolytic gas;
a pump to feed a volume of electrolytic gas generated by the electrochemical cell to the diffuser;
an electrochemical cell controller electrically coupled with plates in the electrochemical cell to control a rate at which the electrochemical cell generates the reducing gas;
a bypass controller for adjusting flow of fluid from the electrochemical cell to the diffuser;
an oxidation reduction potential (ORP) sensor to detect an ORP level of the liquid in the liquid tank; and
a controller to adjust at least one of (a) a rate that the pump feeds the volume of the reducing gas, (b) a rate the electrochemical cell controller causes the plates to generate reducing gas, and (c) the flow of the fluid from the electrochemical cell to the diffuser, based on ORP level detected by the ORP sensor.
